(19) United States
(12) Patent Application Publication
(10) Pub. No.: US 2006/0047894 A1
(43) Pub. Date: Mar. 2, 2006

(54) Data recording apparatus, and data recording control method and program

(75) Inventor: Shoichi Okumura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/005,097

(22) Filed: Dec. 7, 2004

(30) Foreign Application Priority Data
Aug. 30, 2004 (JP) 2004-249987

(51) Int. Cl. G06F 13/00

(52) U.S. Cl. 711/111

(57) ABSTRACT

A data recording apparatus controls writing to and reading from a recording medium such as a magnetic tape, etc. loaded based on input/output requests from a host. A medium information acquiring unit acquires the number of medium marks read out from a memory disposed on a housing of the recording medium when the recording medium has been loaded. Having received an end positioning order from the host, a positioning control unit positions the end position of the recorded portion on the recording medium to the head based on the number of the tape marks acquired by the medium information processing unit.

This application is a priority based on prior application No. JP 2004-249987, filed Aug. 30, 2004, in Japan.

### BACKGROUND OF THE INVENTION

1. Field of the Invention

The present invention relates generally to a data recording apparatus, a data recording control method and program for controlling writing and reading to a cartridge magnetic tape loaded in a magnetic tape drive based on input and output requests from a host, and, more particularly, to a data recording control method and program for positioning the end of a file onto a head at a high speed when another file is additionally written on a cartridge magnetic tape.

2. Description of the Related Arts

Conventionally, in a magnetic tape library apparatus used for backing up of data for a multi-purpose computer, a plurality units of magnetic tape drive are connected with one (1) unit of magnetic tape control apparatus, and these drives and apparatus are housed in one (1) housing. In addition, an automatic loader is provided that automatically executes loading and unloading of a cartridge magnetic tape to the magnetic tape drive and each of the magnetic tape drives is adapted to write back-up data requested from a host changing continuously the cartridge magnetic tape using the automatic loader when the magnetic tape control apparatus has received from the host an order to write data. The data that the magnetic tape drive controlled by the magnetic tape control apparatus writes into the cartridge magnetic tapes in this manner is written in data units referred to as “file” in case of LTO (Linear Tape-Open) known as a standard for cartridge magnetic tapes.

FIG. 1 is a file format according to the LTO standard recorded on a cartridge magnetic tape and one (1) file comprises an area (HDR) 100 that is the area for the name of the file to be written in, an actual data area (DATA) 102 and an area (EOF) 104 indicating the end of the file and these areas are partitioned individually by tape marks (TMs) 106-1, 106-2 and 106-3.

FIG. 2 is an illustrative diagram of a format on a cartridge magnetic tape to which a plurality of files are written partway and a plurality of files 110-1 to 110-m that take a format configuration of FIG. 7B are already recorded following a volume (VOL) 108 that is at the front end on the tape and defines a logic area. Here, when a file is written additionally to the recorded files 110-1 to 110-m, it is necessary to detect a data end mark (EOD) 110 recorded following the end of the last file 110-m and position the data end mark (EOD) 110 to the head (see, e.g., Japanese Patent Application Laid-Open Publication Nos. 1990-23556, 1995-93956, 1999-534869 and 1995-66653, and Japanese Patent No. 2853861).

However, in such a conventional magnetic tape control apparatus, only a space file command for reading information on the tape skipping the tape marks one by one is provided and, as shown in FIG. 2, a process for issuing the command and skipping the tape mark must be executed so many times as represented by space file commands 114-1 to 114-n until a data end mark (EOD) 112 arranged at the end of files is detected. Therefore, a problem is arisen that it takes an enormous amount of time until the data end mark (EOD) 112 is detected when the length of a recorded portion on a tape is long.

### SUMMARY OF THE INVENTION

According to the present invention there are provided a data recording apparatus, and a data recording control method and program that enable the end of a recorded portion on a magnetic tape to be positioned to a head at a high speed. The present invention provides a data recording apparatus that controls writing to and reading from a recording medium based on input and output requests from a host, the data recording apparatus comprising:

a medium information acquiring unit acquiring the number of medium marks from a memory disposed on a housing of the recording medium when the recording medium is loaded; and

a positioning control unit positioning the end position of recording on the recording medium to a head based on the number of the medium marks acquired from the memory when an end positioning order is received from the host.

The positioning control unit counts the medium marks read out from the recording medium while running the recording medium from its forefront position, the positioning control unit stopping the running of the medium at a position where the counted value of the medium marks coincides with the number of the medium marks acquired by the medium information acquiring unit to position the end position to the head. In the data recording apparatus of the present invention, the recording medium has data recorded therein on a file-by-file basis, the file being formatted including a header area for describing the name of the file in, a medium mark, a data area for recording data in, a medium mark, a file end area and a medium mark, the positioning control unit reading three (3) medium marks for each of the files to count those medium marks, the positioning control unit stopping the running of the medium at a position where the counted value coincides with the number of the medium marks acquired by the medium information acquiring unit to position the end position of the last file to the head. The positioning control unit issues a positioning command ordering to run and stop the recording medium at a position reached after skipping N medium marks where N is the number of the medium marks acquired by the medium information acquiring unit. The data recording apparatus of the present invention further comprises a medium information processing unit detecting the total number of the medium marks written from the starting position of the medium marks to the end of data on the recording medium to write the detected total number into a memory disposed on the housing of the recording medium prior to unloading of the recording medium.

The present invention provides a data recording apparatus control method for controlling writing into and reading from a recording medium loaded based on input and output requests from a host. To this end, the data recording apparatus control method of the present invention comprises:

a step of acquiring the number of medium marks from a memory disposed on a housing of the recording medium when the recording medium is loaded; and

a positioning control step of positioning the end position of recording on the recording medium to a head based on the number of the medium marks acquired from the memory when an end positioning order is received from the host.

The present invention provides a program run by a computer of a data recording apparatus that controls writing to and reading from a recording medium based on input and output requests from a host to execute. The program of the present invention is operable to drive the computer to execute:

a medium information acquisition step of acquiring the number of medium marks from a memory disposed on a housing of the recording medium when the recording medium is loaded; and

a positioning control step of positioning the end position of recording on the recording medium to a head based on the number of the medium marks acquired from the memory when an end positioning order is received from the host.

The details of the data recoding apparatus control method and program are essentially the same as those of the data recording apparatus of the present invention. According to the present invention, the number of medium marks such as the number of tape marks, etc. acquired from recorded files is written as a piece of medium information in a memory disposed on the housing of the recording medium such as a magnetic tape, etc. Therefore, by reading the number of the medium marks from the memory and skipping from the medium mark at the forefront of the medium to the last medium mark at the end of the recording of files based on this number of the medium marks when the recording medium has been loaded, the end of data that is the end of the last recorded file can be positioned to the head at a high speed and the processing speed for additionally writing a file can be improved. The above and other objects, features and advantages of the present invention will become more apparent from the following detailed description with reference to the drawings.

### BRIEF DESCRIPTION OF THE DRAWINGS

FIG. 1 is a illustrative diagram of a file format according to LTO standard;

FIG. 2 is an illustrative diagram of a format of conventional positioning control of the end of files to a head when a plurality of files are recorded on a cartridge magnetic tape;

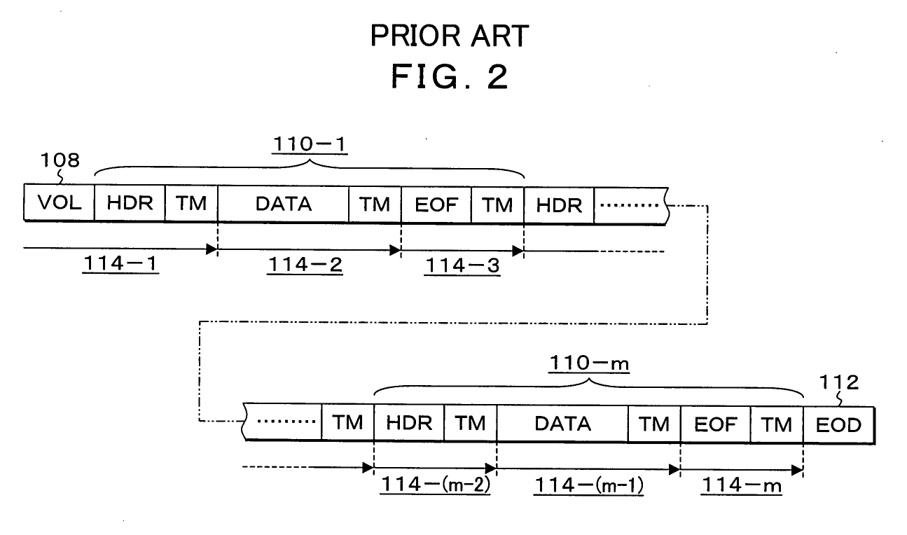

FIG. 3 is an illustrative diagram of a magnetic tape library apparatus applied with the present invention;

FIG. 4 is a block diagram showing an embodiment of a magnetic tape control apparatus according to the present invention together with a magnetic tape drive and a host;

FIG. 5 is an illustrative diagram of medium information stored in a cartridge memory of FIG. 3;

FIG. 6 is an illustrative diagram of a format according to which a plurality of files are recorded on the cartridge magnetic tape of FIG. 3;

FIG. 7A is a flowchart for a magnetic tape control process of the present invention for executing high-speed positioning of the end of recording on a tape; and

FIG. 7B is a flowchart of the magnetic tape control process continued from FIG. 7A.

### DETAILED DESCRIPTION OF THE PREFERRED EMBODIMENT

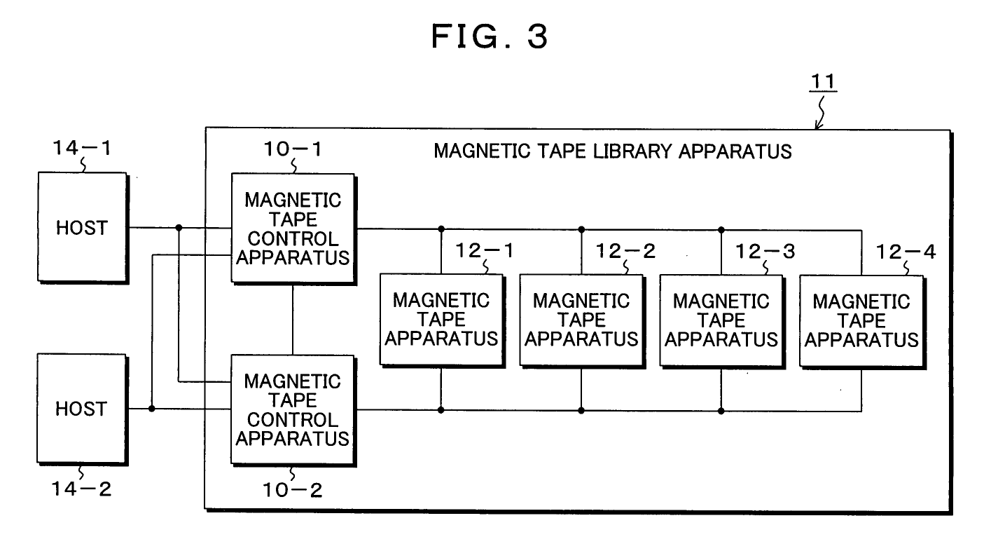

FIG. 3 shows a magnetic tape library apparatus taken as an example of a data recording apparatus of the present invention and a magnetic tape housed in a cartridge is used as a recording medium. In FIG. 3, a magnetic tape library apparatus 11 comprises two (2) magnetic tape control apparatuses 10-1 and 10-2, and the magnetic tape control apparatuses 10-1 and 10-2 are connected with, for example, four (4) magnetic tape drives 12-1, 12-2, 12-3 and 12-4. The magnetic tape library apparatus 11 connects, for example, two (2) hosts 14-1 and 14-2 with the magnetic tape control apparatuses 10-1 and 10-2 and, having received input and output requests from the hosts 14-1 and 14-2, executes recording and reproducing of information to a cartridge magnetic tape using any one of the magnetic tape drives 12-1 to 12-4. Multi-purpose computers are usually used as the hosts 14-1 and 14-2 and the magnetic tape library apparatus 11 is used as, for example, a back-up magnetic tape sub system for backing up a large amount of data processed by the hosts 14-1 and 14-2. Each of the magnetic tape drives 12-1 to 12-4 is usually equipped with an automatic loader and a large amount of data can be written into the plurality of cartridge magnetic tape continuously in response to the writing of, for example, back-up data from the hosts 14-1 and 14-2 by repeating loading and unloading continuously a plurality of cartridge magnetic tapes to the magnetic tape drives using the automatic loader.

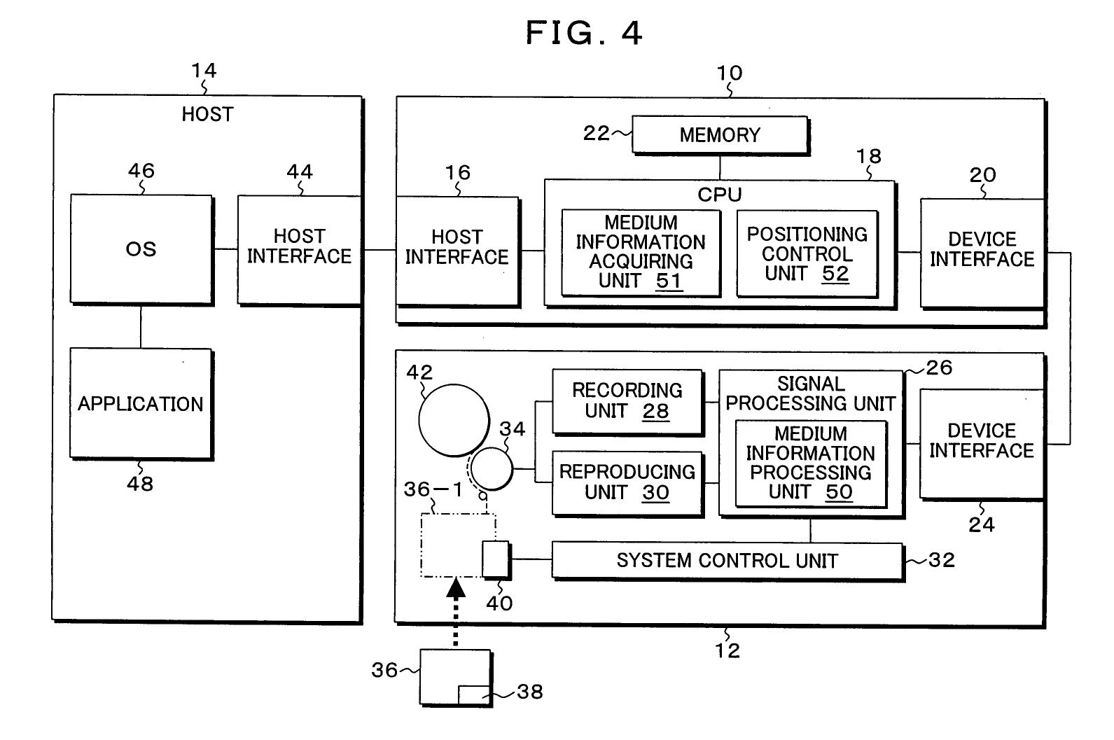

FIG. 4 is a block diagram showing an embodiment of the data recording apparatus according to the present invention configured by a magnetic tape control apparatus 10 and a magnetic tape drive 12, together with a host. In FIG. 4, the magnetic tape control apparatus 10 comprises a host interface 16, a CPU 18, a device interface 20 and a memory 22 and is provided with functions of a medium information acquiring unit 51 and a positioning control unit 52 for controlling positioning of the end of a file recorded on the cartridge magnetic tape as functions realized by executing a program by the CPU 18. The magnetic tape drive 12 is provided with a device interface 24, a signal processing unit 26, a recording unit 28, a reproducing unit 30, a system control unit 32, a head drum 34, a reader/writer 40 and a tape reel 42 and is adapted to execute recording running, reproducing running, winding and rewinding of the tape by loading a cartridge magnetic tape 36 to the head drum 34 such that the tape 36 is set as shown by an imaginative line 36-1, drawing out the tape, winding the tape around the head drum within the range of, for example, 90 degrees and, thereafter, connecting the tape with the tape reel 42. A cartridge memory 38 is disposed on a housing of the cartridge magnetic tape 36. The cartridge memory 38 is a nonvolatile memory and various medium information relating to the cartridge magnetic tape 36 is recorded therein. The number of tape marks N showing the total number of the tape marks that are the medium marks used for the high-speed positioning of the file end position on the tape of the present invention is included in this medium information. Here, the magnetic tape control apparatus 10 and the magnetic tape drive 12 support the LTO standard. An “OTS2 Magnetic Tape Control Apparatus” from Fujitsu Ltd., for example, is used as the magnetic tape control apparatus 10 and an “LTO Ultrium 2” from IBM can be used as the magnetic tape drive 12. In this case, “SCSI Interfaces” can be used as the device interfaces 20 and 24 connecting between the magnetic tape control apparatus 10 and the magnetic tape drives 12 and, more specifically, “Ultra2/Wide LVDs (Low-Voltage Differentials), etc. are used. In the case where magnetic tape drives from IBM, for example, are used as the magnetic tape drives 12, data of 200 gigabytes can be stored on the cartridge magnetic tape 36 when the data are compressed. Then, the size of the compressed data is 100 gigabytes. The system control unit 32 of the magnetic tape drive 12 executes rotation control of the head drum 34, tape running control of the cartridge magnetic tape 36 that has been loaded, etc. The signal processing unit 26 converts the file format of the data sent in response to a write command from the magnetic tape control apparatus 10 into the file format according to the LTO standard and outputs the converted data from the recording unit 28 to the head drum 34 to record the converted data on a magnetic tape. When a read command has been received from the magnetic tape control apparatus 10, a signal read by the head drum 34 is processed in the reproducing unit 30 and, thereafter, is inputted into the signal processing unit 26. Then, data is decoded by a format inverse transformation in the signal processing unit 26 and is transferred to the magnetic tape control apparatus 10. The host 14 provided as a higher-order apparatus for the magnetic tape control apparatus 10, is provided with a host interface 44, an OS 46 and an application 48. The application 48 executes processes such as backing up and decoding of data processed in the host 14 into/from the magnetic tape drive 12, etc. and, based on these processes, the OS 46 issues input and output requests in the form of commands to the magnetic tape control apparatus 10 through the host interface 44. When a data write order is issued from the host 14, after data to be written is transferred from the memory 22 of the magnetic tape control apparatus 10 and is stored, the data is read out in data units each of which becomes the file size of LTO standard, is sent to the magnetic tape drive 12, is converted into a file format and is recorded on a magnetic tape. When a data read order is issued from the host 14, after data read out from the magnetic tape drive 12 is also stored temporarily in the memory 22, the CPU 18 transfers the data to the host 14 side as a read response. The signal processing unit 18 of the magnetic tape drive 12 is provided with a medium information processing unit 50 and reads the medium information recorded in the cartridge memory 38 disposed on the housing of the cartridge magnetic tape 36, using the reader/writer 40 and reads the number of the tape marks included in the medium information as a piece of the information when the cartridge magnetic tape 36 has been loaded onto the magnetic tape drive 12. The medium information processing unit 50 detects the number of the tape marks recorded from the forefront to the end of files currently recorded on a tape of the cartridge magnetic tape 36 prior to unloading of the cartridge magnetic tape 36 from the magnetic tape drive 12, and writes the detected number of the tape marks from the reader/writer 40 into the cartridge memory 38 of the cartridge magnetic tape 36. Thereafter, the cartridge magnetic tape 36 is caused to be unloaded. The CUP 18 of the magnetic tape control apparatus 10 is provided with the functions of the medium information acquiring unit 51 and the medium information processing unit 52. The medium information acquiring unit 51 acquires the number of the tape marks N read from the cartridge memory 38 by the medium information processing unit 50 of the magnetic tape drive 12. When the positioning control unit 52 has received an end positioning order for files recorded on the magnetic tape from the host 14, the positioning control unit 52 orders and causes the magnetic tape drive 12 to execute a positioning control for positioning the end position of recording on the tape to the rotary head 34 based on the number of the tape marks N acquired by the medium information acquiring unit 51. This control executed by the positioning control unit 52 issues to the magnetic tape drive 12 a positioning command, more specifically a “space N file command” for running and stopping the tape at a position after skipping N tape marks, assuming the number of the tape marks acquired by the medium information acquiring unit 51 is N. This positioning command represents control by which the tape marks read out are counted while the cartridge magnetic tape 36 is run from the forefront position in response to the control of the magnetic tape drive 12, the running of the tape is stopped at a position where the counted value of the tape marks coincides with the acquired number of the tape marks N, and the end position of the recording is positioned to the head drum 34.

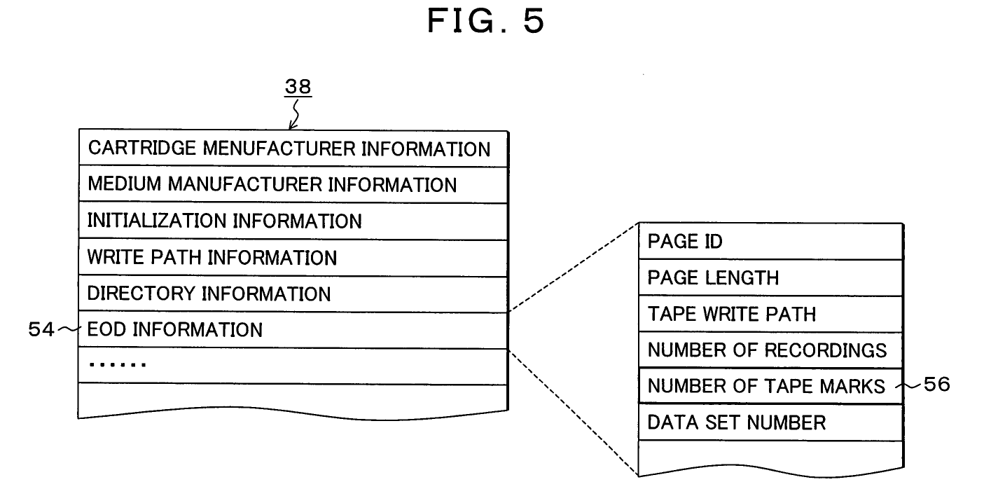

FIG. 5 is an illustrative diagram of the medium information recorded in the cartridge memory 38 of FIG. 3. In FIG. 5, as the medium information, cartridge manufacturer information, medium manufacturer information, initialization information, write path information, directory information, EOD information 54, etc. are stored in the cartridge memory 38. Among these, in the EOD information 54, the number of tape marks 56 used in the high-speed positioning of the present invention is recorded in addition to a page ID, the number of pages, a tape write path, the number of recordings as illustrated taken out on the right. The number of tape marks necessary for the high-speed positioning of the present invention can be acquired by reading this medium information in the cartridge memory 38.

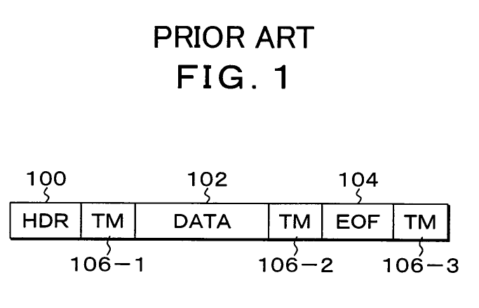

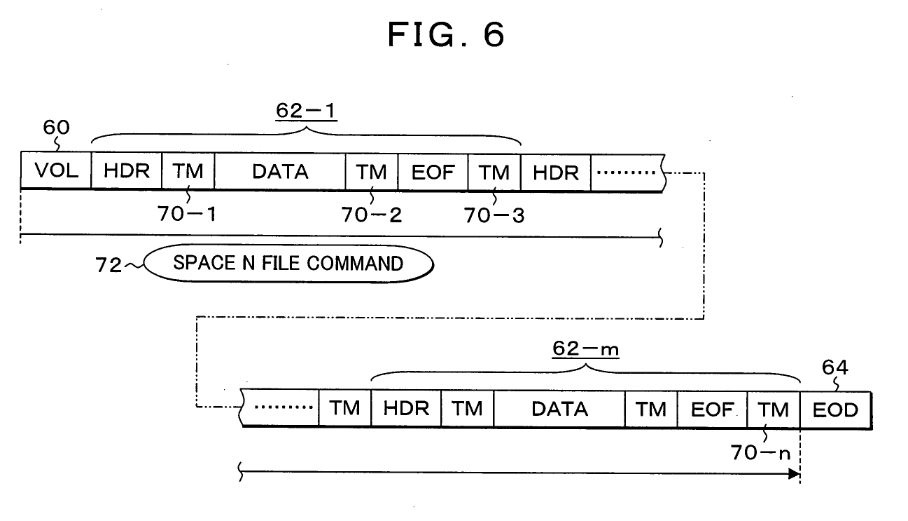

FIG. 6 is an illustrative diagram of a format for the case where a plurality of files are recorded on the cartridge magnetic tape of FIG. 3. In FIG. 6, a volume (VOL) 60 representing the logic configuration of the tape recording information is provided at the forefront of the magnetic tape and, following this, files 62-1 to 62-m are recorded. Similarly to the file format of the LTO standard shown in FIG. 1, each of the files 62-1 to 62-m comprises a HRD area that is the area for the name of the file to be written in, an actual data area (DATA) and an area (EOF) indicating the end of the file, and those areas are partitioned individually by tape marks (TMs) 70-1, 70-2 and 70-3. Because three (3) tape marks are disposed on each one (1) file as described above, the number of tape marks for n files of the files 62-1 to 62-n of FIG. 6 is
N=3×n
and this can be acquired as the number of tape marks 56 in the cartridge memory 34 shown in FIG. 5. When a new file is additionally recorded following the last file 62-n on the magnetic tape taking the format configuration of FIG. 6, a positioning order for the end of the last file is issued from the host 14 to the magnetic tape control apparatus 10. This order from the host 14 to position to the end of the files is given more specifically as a file additional writing order to record data additionally. Having received the file additional writing order from the host 14, the positioning control unit 52 disposed on the CPU 18 of the magnetic tape control apparatus of FIG. 4 operates and issues a space N file command 72 to the magnetic tape drive 12. In response to this command, the tapemarks (TM) 70-1, 70-2, 70-3, . . . , 70-n acquired one after another by the reading from the forefront of the tape are skipped by N marks, the data end mark (EOD) 64 is positioned such that the mark 64 is at the head drum 34, and the running of the tape is stopped.

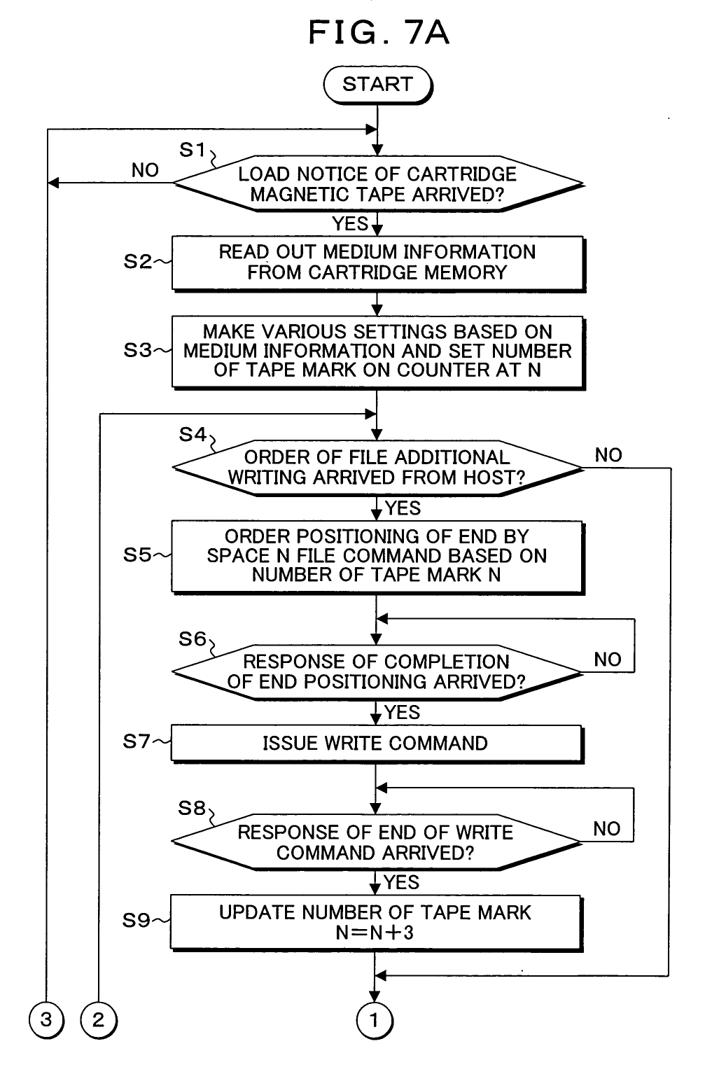

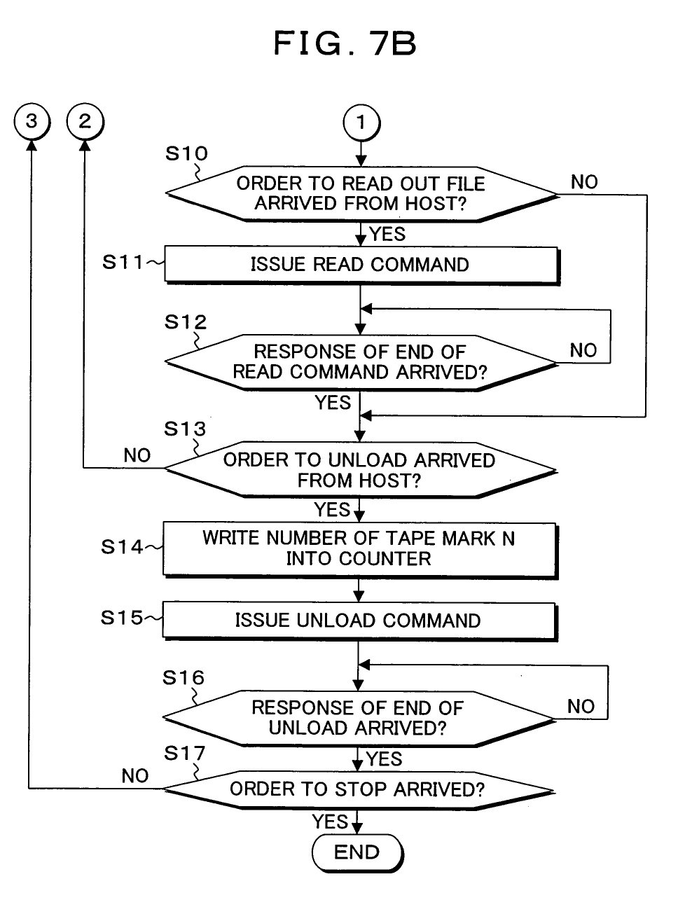

FIGS. 7A and 7B together are flowcharts for the magnetic tape control apparatus of the present invention that executes the high-speed positioning of the end of recording on a tape. In FIG. 7A, when a notice of loading of the cartridge magnetic tape 36, from the magnetic tape drive 12 has been identified at a step S1, the procedure advances to a step S2 at which the cartridge memory 38 disposed on the loaded cartridge magnetic tape 36 is read by the reader/writer 40 and medium information is read out. Then, the number of the tape marks N read out is set on a counter as the initial value simultaneously with various settings based on the medium information read out from the cartridge memory 38 at a step S3. Next, a file additional writing order from the host 14 is checked at a step S4 and, if the file additional writing order is present, the procedure advances to a step S5 at which positioning to the file end is ordered by issuing to the magnetic tape drive a space N file command based on the number of the tape marks N acquired currently. Having received this space N file command, the magnetic tape drive 12 executes running and stopping of the tape such that the end position of the tape (EOD) comes to the head drum 34 after skipping N tape marks from the forefront of the tape as shown in the file format on the magnetic tape of FIG. 6, and positions the end position of the files to the head drum 34. When positioning of the end position of the files by the magnetic tape drive 12 has been completed, a completion response of end position positioning is acquired and the procedure advances to a step S7 at which a write command to additionally write a file, together with data to write, is issued to the magnetic tape drive 12 and the magnetic tape drive 12 is caused to execute the additional writing of the file. When the additional writing of the file has been completed by the magnetic tape drive 12, a write command completion response is identified at a step S8. Therefore, the procedure advances to a step S9 at which updating of the number of the tape marks as updating of the number of the tape marks accompanied by the additional writing of the file is executed as
N=N+3
because the number of the tape marks per one (1) file is three (3). Next, whether or not a file read-out order from the host 14 is present is checked at a step S10 and, if the read-out order is present, the procedure advances to a step S11 at which a read command is issued to the magnetic tape drive 12 and, at a step S12, a file read-out process is ended if a read command completion response is received. Furthermore, whether or not an unload order from the host 14 is present is checked at a step S13 and, if the unload order is present, the procedure advances to a step S14 of the FIG. 7B at which the current number of the tape marks N counted by the counter is written into the cartridge memory 38 of the cartridge magnetic tape 36 through the reader/writer 40. Thereafter, the magnetic tape drive 12 is caused to eject the cartridge magnetic tape 36 by an unload command issued thereto at a step S15. When the cartridge magnetic tape 36 has been disused, an unload completion response is received at a step S16. Moreover, whether or not an order to stop is present is checked at a step S17 and the process steps from the step S1 are repeated until the order to stop is received. Furthermore, the present invention provides a program executed by a computer, that is, the CPU 18 constituting the magnetic tape control apparatus 10 functioning as the medium information acquiring unit 51 and the positioning control unit 52 of FIG. 3. The magnetic tape control apparatus 10 is loaded with a program having the content of the flowchart of FIGS. 7A and 7B of the present invention for positioning the end of recording on a tape at a high-speed, in a hard disk drive thereof not shown, and a necessary program is evoked from the hard disk drive, is deployed on an RAM and is executed by the CPU 18 when the computer is started up. Furthermore, in the flowchart of FIGS. 7A and 7B, the number of the tape marks is adapted to be updated by counting the number in real time accompanied by the additional writing of the file. However, the magnetic tape control apparatus also manages the number of the files on the tape. Therefore, because the number of the tape marks of one (1) file is fixed to be three (3), the number of the tape marks may be written into the cartridge memory 38 by calculating the number of the tape marks from the number of the files already recorded when the unload order has been received. Though the above embodiment of the present invention takes an example of a tape medium as the recording medium, the present invention is not limited to the embodiment and any appropriate recording medium may be used as far as information is written on or read from the medium using a head, and any recording form may be employed as far as the recording form is adapted to record medium marks corresponding to the tape marks, for each unit of data recording as a recording format of the recording medium. Furthermore, though the data recording apparatus of the present invention is configured by externally connecting the magnetic tape control apparatus 10 and the magnetic tape drive 12 with each other using the device interfaces 20 and 24 in the embodiment of FIG. 4, the magnetic tape control apparatus 10 and the magnetic tape drive 12 may be integrated as one (1) apparatus by housing the magnetic tape control apparatus 10 and the magnetic tape drive 12 in a single housing. Yet furthermore, the present invention is not limited to the above embodiment, but encompasses any appropriate variations thereof without impairing the object and advantages thereof and is not intended to be limited by the numerical values shown in the above embodiment.

What is claimed is:

1. A data recording apparatus that controls writing to and reading from a recording medium based on input and output requests from a host, the data recording apparatus comprising:
a medium information acquiring unit acquiring the number of medium marks from a memory disposed on a housing of the recording medium when the recording medium is loaded; and
a positioning control unit positioning the end position of recording on the recording medium to a head based on the number of the medium marks acquired from the memory when an end positioning order is received from the host.

2. A data recording apparatus according to claim 1, wherein the positioning control unit counts the medium marks read out from the recording medium while running the recording medium from its forefront position, the positioning control unit stopping the running of the medium at a position where the counted value of the medium marks coincides with the number of the medium marks acquired by the medium information acquiring unit to position the end position to the head.

3. A data recording apparatus according to claim 1, wherein
the recording medium has data recorded therein on a file-by-file basis, wherein
the file is formatted including a header area for describing the name of the file in, a medium mark, a data area for recording data in, a medium mark, a file end area and a medium mark, and wherein
the positioning control unit reads three (3) medium marks for each of the files to count those medium marks, the positioning control unit stopping the running of the medium at a position where the counted value coincides with the number of the medium marks acquired by the medium information acquiring unit to position the end position of the last file to the head.

4. A data recording apparatus according to claim 1, wherein the positioning control unit issues a positioning command ordering to run and stop the recording medium at a position reached after skipping N medium marks where N is the number of the medium marks acquired by the medium information acquiring unit.

5. A data recording apparatus according to claim 1, further comprising a medium information processing unit detecting the total number of the medium marks written from the starting position of the medium marks to the end of data on the recording medium to write the detected total number into a memory disposed on the housing of the recording medium prior to unloading of the recording medium.

6. A data recording apparatus control method for controlling writing into and reading from a recording medium loaded based on input and output requests from a host, the method comprising:
a step of acquiring the number of medium marks from a memory disposed on a housing of the recording medium when the recording medium is loaded; and
a positioning control step of positioning the end position of recording on the recording medium to a head based on the number of the medium marks acquired from the memory when an end positioning order is received from the host.

7. A data recording apparatus control method according to claim 6, wherein the positioning control step includes counting the medium marks read out from the recording medium while running the recording medium from its forefront position, and stopping the running of the medium at a position where the counted value of the medium marks coincides with the number of the medium marks acquired by the medium information acquiring unit to position the end position to the head.

8. A data recording apparatus control method according to claim 6, wherein
the recording medium has data recorded therein for reproduction on a file-by-file basis, wherein
the file is formatted including a header area for describing the name of the file in, a medium mark, a data area for recording data in, a medium mark, a file end area and a medium mark, and wherein
the positioning control step includes reading three (3) medium marks for each of the files to count those medium marks, and stopping the running of the medium at a position where the counted value coincides with the number of the medium marks acquired by the medium information acquiring unit to position the end position of the last file to the head.

9. A data recording apparatus control method according to claim 6, wherein the positioning control step includes issuing a positioning command ordering to run and stop the recording medium at a position reached after skipping N medium marks where N is the number of the medium marks acquired by the medium information acquiring unit.

10. A data recording apparatus control method according to claim 6, further comprising a step of detecting the total number of the medium marks written from the starting position of the medium marks to the end of data on the recording medium to write the detected total number into a memory disposed on the housing of the recording medium prior to unloading of the recording medium.

11. A program operable to drive a computer of a data recording apparatus that controls writing to and reading from a recording medium based on input and output requests from a host to execute:
a medium information acquisition step of acquiring the number of medium marks from a memory disposed on a housing of the recording medium when the recording medium is loaded; and
a positioning control step of positioning the end position of recording on the recording medium to a head based on the number of the medium marks acquired from the memory when an end positioning order is received from the host.

12. A program according to claim 11, wherein the positioning control step includes counting the medium marks read out from the recording medium while running the recording medium from its forefront position, and stopping the running of the medium at a position where the counted value of the medium marks coincides with the number of the medium marks acquired by the medium information acquiring unit to position the end position to the head.

13. A program according to claim 11, wherein
the recording medium has data recorded therein for reproduction on a file-by-file basis, wherein
the file is formatted including a header area for describing the name of the file in, a medium mark, a data area for recording data in, a medium mark, a file end area and a medium mark, and wherein
the positioning control step includes reading three (3) medium marks for each of the files to count those medium marks, and stopping the running of the medium at a position where the counted value coincides with the number of the medium marks acquired by the medium information acquiring unit to position the end position of the last file to the head.

14. A program according to claim 11, wherein the positioning control step includes issuing a positioning command ordering to run and stop the recording medium at a position reached after skipping N medium marks where N is the number of the medium marks acquired by the medium information acquiring unit.

15. A program according to claim 11, the program driving the computer to further execute a step of detecting the total number of the medium marks written from the starting position of the medium marks to the end of data on the recording medium to write the detected total number into a memory disposed on the housing of the recording medium prior to unloading of the recording medium.
